(19) United States
(12) Patent Application Publication
(10) Pub. No.: US 2014/0156540 A1
(43) Pub. Date: Jun. 5, 2014

(54) SYSTEM AND METHOD FOR MANAGING DATABASE OF BUYERS

(71) Applicant: BuyerMLS, LLC, Wayne, PA (US)

(72) Inventors: Charles Williams, Wayne, PA (US); John L. Heithaus, Rockville, MD (US); Brian Preston, Chalfont, PA (US); Jeremy Elser, Philadelphia, PA (US)

(73) Assignee: BuyerMLS, LLC, Wayne, PA (US)

(21) Appl. No.: 13/913,076

(22) Filed: Jun. 7, 2013

Related U.S. Application Data
(60) Provisional application No. 61/657,317, filed on Jun. 8, 2012.

(51) Int. Cl. G06Q 50/16; G06F 17/30

(52) U.S. Cl. CPC G06Q 50/16; G06F 17/30477
USPC 705/306; 705/313

(57) ABSTRACT

A system and method for managing a database of buyers includes a server configured to store a buyers database having data related to a plurality of buyers. For each of the plurality of buyers, the data includes buyer identification information for the buyer, purchasing criteria of the buyer, and buyer agent information associated with the buyer. The server is further configured to retrieve and store in the buyers database supplemental information about each buyer based upon the buyer identification information. The server receives a first query of the buyers database from a first remote device, the first query returning first query results which includes the purchasing criteria and buyer agent information for each buyer included in the first query results. The server transmits the first query results to the first remote device.

### CROSS REFERENCE TO RELATED APPLICATIONS

Priority is claimed to U.S. provisional patent application No. 61/657,317 filed Jun. 8, 2012, the disclosure of which is incorporated hereto by reference in its entirety.

### FIELD OF THE INVENTION

The field of the present invention relates to a system and method for creating and providing access to a database for buyers which allows agents to better match buyers with properties being offered for sale.

### BACKGROUND OF THE INVENTION

There are inefficiencies inside real estate brokerages in announcing new buyers. The current methods include two inefficient techniques: 1) verbal announcement during weekly office meetings—this method is inefficient because verbal announcements are only heard by those attending. Attendance of all local agents is restricted to only those working for said brokerage meaning almost every agent in the local area cannot attend or hear what buyers are actively looking. Of those agents working, for said brokerage only 30%-40% attend the meetings. Of the 30%-40% who attend only those that have listings pay attention. The agents who have the matching listing are most often not at these meetings or don't have a matching listing until after the meeting and by then they forgot who announced the matching buyer. 2) Mass emails describing the buyer's criteria are sent to agents inside the office. Unfortunately these entails are often automatically moved to a spam folder or not read because of the overwhelming amounts of emails that agents receive. Thus the proper match does not get made.

Secondly it has been documented that 89% of buyers are working with an agent meaning agents already have the buyers. When a listing agent lists a property for sale in the MLS they also spend advertising money in looking for a buyer. The buyer does not need to be looked for because an agent is already working them. However, there is no system in place that allows this buyer agent to post that buyer's criteria so the listing agent can contact the buyer's agent.

### SUMMARY OF THE INVENTION

The present invention is directed toward a system and method for managing a database of buyers. A server is configured to store a buyers database which includes data related to a plurality of buyers. The data includes at least buyer identification information for the buyer and purchasing criteria of the buyer. The server is further configured to receive queries of the buyers database from remote devices and to return query results to the remote devices in response to each query.

In a first separate aspect of the present invention, a method for managing a database of buyers comprises storing, at a server, a buyers database comprising data related to a plurality of buyers. For each of the plurality of buyers, the data includes buyer identification information for the buyer, purchasing criteria of the buyer, and buyer agent information associated with the buyer. Supplemental information from an information source about each buyer based upon the buyer identification information is retrieved by the server and stored by the server in the buyers database. A first query of the buyers database is received at the server from a first remote device, wherein the first query returns first query results including the purchasing criteria and buyer agent information for each buyer included in the first query results. These first query results are transmitted to the first remote device.

In a second separate aspect of the present invention, a method for managing a database of buyers comprises storing, at a server, a buyers database comprising data related to a plurality of buyers. For each of the plurality of buyers, the data includes buyer identification information for the buyer, purchasing criteria of the buyer, and buyer agent information associated with the buyer. Geographical location data is received by the server from a plurality of remote devices, each associated with one of a plurality of active buyers in the buyers database. A first query of the buyers database is received at the server from a first remote device, wherein the first query returns first query results including the purchasing criteria and buyer agent information for each of the active buyers included in the first query results, with the active buyers being grouped by proximity to a geographical location identified in the first query. These first query results are transmitted to the first remote device.

In a third separate aspect of the present invention, a method for managing a database of buyers comprises storing, at a server, a buyers database comprising data related to a plurality of buyers. For each of the plurality of buyers, the data includes buyer identification information for the buyer, purchasing criteria of the buyer, and buyer agent information associated with the buyer. A first query of the buyers database is received at the server from a first remote device, wherein the first query returns first query results including the purchasing criteria and buyer agent information for each buyer included in the first query results, with the plurality of buyers included in the first query results being grouped by purchasing criteria having a common geographical identifier. These first query results are transmitted to the first remote device.

In a fourth separate aspect of the present invention, a method for managing a database of buyers comprises storing, at a server, a buyers database comprising data related to a plurality of buyers. For each of the plurality of buyers, the data includes buyer identification information for the buyer, purchasing criteria of the buyer, and buyer agent information associated with the buyer. A property listings database is stored at the server, with this database comprising data related to a plurality of properties for sale, for each of the plurality of properties, property features. One or more of the buyers is matched, by the server, to one or more of the properties, and a market value of one or more of the matched properties is estimated by the server based upon the purchasing criteria of the one or more matched buyers. These estimated market values are transmitted in response to receiving a query for the market values.

In a fifth separate aspect of the present invention, a method for managing a database of buyers comprises storing, at a server, a buyers database comprising data related to a plurality of buyers. For each of the plurality of buyers, the data includes buyer identification information for the buyer, purchasing criteria of the buyer, and buyer agent information associated with the buyer. The purchasing criteria includes a plurality of predetermined categorizations and at least one free form entry field. A first query of the buyers database is received at the server from a first remote device, wherein the first query returns first query results by applying an inference matching algorithm to the at least one free form entry field. The first query results include the purchasing criteria and buyer agent information for each buyer included in the first query results. These first query results are transmitted to the first remote device.

In a sixth separate aspect of the present invention, a network comprises at least one server configured to execute non-transitory computer executable code, with the code instructing the server to store a buyers database comprising data related to a plurality of buyers. For each of the plurality of buyers, the data includes buyer identification information for the buyer, purchasing criteria of the buyer, and buyer agent information associated with the buyer. The server retrieves supplemental information from an information source about each buyer based upon the buyer identification information, and the server stores the supplemental information in the buyers database. The server receives a first query of the buyers database from a first remote device, wherein the first query returns first query results including the purchasing criteria and buyer agent information for each buyer included in the first query results. These first query results are transmitted to the first remote device.

In a seventh separate aspect of the present invention, one or more features of any of the forgoing aspects may be used in combination.

Accordingly, an improved system and method for managing a database of buyers are disclosed. Advantages of the improvements will be apparent from the drawings and the description of the preferred embodiment.

### BRIEF DESCRIPTION OF THE DRAWINGS

The foregoing summary, as well as the following, detailed description of the exemplary embodiments, will be better understood when read in conjunction with the appended drawings. It should be understood, however, that the invention is not limited to the precise arrangements and instrumentalities shown in the following figures:

FIG. 1 schematically illustrates a system for managing a buyers database;

FIG. 2 schematically illustrates data inputs into the buyers database, along with examples of outputs;

FIG. 3 schematically illustrates a process flow for building and querying a buyers database;

FIG. 4 illustrates a first form for gathering information about a buyer;

FIG. 5 illustrates a second form for gathering information about a buyer;

FIG. 6 illustrates query results showing a list of buyers from the buyers database;

FIG. 7 illustrates a detailed view of a listing for a buyer from the buyers database;

FIG. 8 illustrates a messaging pane from within the buyers database management system;

FIG. 9 illustrates a query and query results showing a list of buyers from the buyers database;

FIG. 10 illustrates the query and query results of FIG. 9 without the advanced options;

FIG. 11 illustrates an initial landing page for an unregistered user accessing a buyers database system;

FIG. 12 illustrates a listing of active: buyers for an agent accessing a buyers database system;

FIG. 13 illustrates a listing of active buyers and their associated prequalification rating; and

FIG. 14 illustrates a listing of active buyers matching a specific property.

### DETAILED DESCRIPTION OF THE INVENTION

Features of the present invention may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g. desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g. software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs is referred to hereinafter as a “programmable device”, or just a “device” for short, and multiple programmable devices in mutual communication is referred to as a “programmable system”. It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g. internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

The description that follows is in the context of real property, and specifically managing a database for buyers of real property. The invention is not to be so limited. One of ordinary skill in the art will appreciate that a buyers database may be used in connection with any property, whether real or personal, that is bought and sold within a marketplace. For example, a buyers database could be implemented with respect to high priced items, such as automobiles, boats, luxury yachts, and airplanes. By way of another example, a buyers database could be implemented for collectibles, such as coins and stamps, for which a sizeable market exists. By way of yet another example, a buyers database could be implemented for personal property that is considered a commodity, such as computers, tablets, or cell phones, and embodiments of it could even be implemented for consumable products. The term “property”, therefore, as used herein, is not to be limited to real property, to any particular type of property, or to property having any particular value.

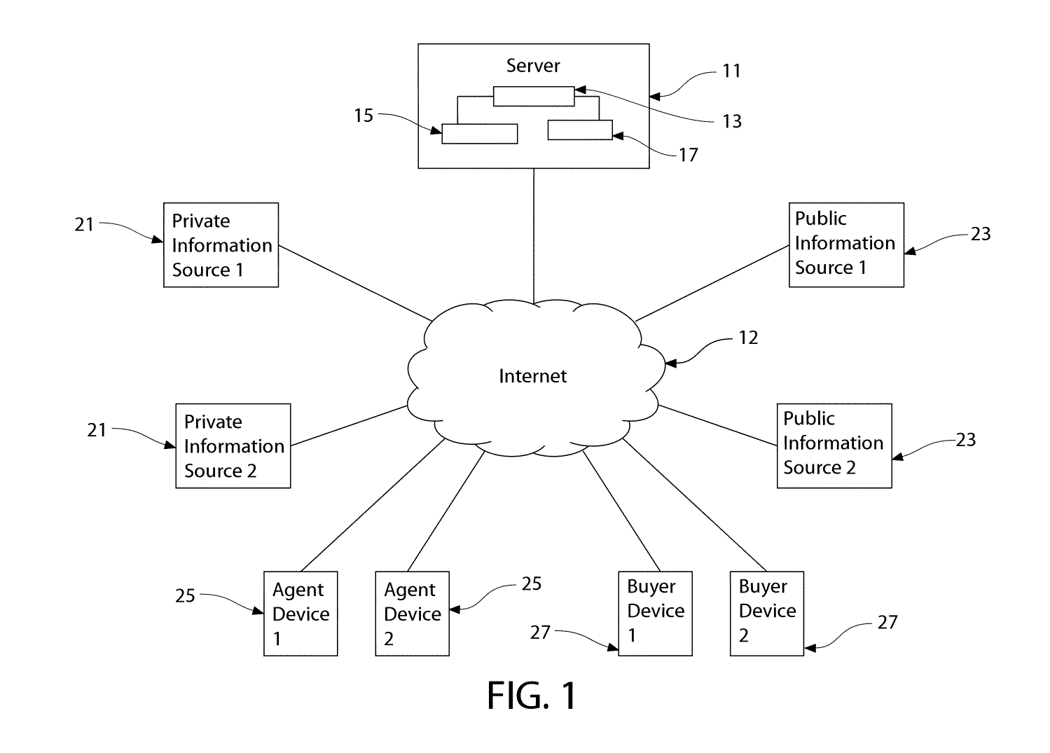

A system for managing a buyers database is illustrated in FIG. 1. The system includes a server 11 which operates in a networked environment to interact with other programmable devices and networks. The network environment may include and operate over a public network such as the Internet 12, over a private network, or any combination of public and private networks. The networks themselves may be wired networks, wireless networks, or again, any combination of wired and wireless networks. The server in the embodiment shown includes a processor 13, a volatile memory 15, and a non-volatile storage device 17. Additional processors, volatile memory spaces, and non-volatile storage devices may be included as desired based on specifications of a particular implementation.

In the embodiment illustrated, the server 11 is networked using a public network 12 to a plurality of different programmable devices and/or programmable systems. Each device and system to which the server 11 is networked serves as a point of data acquisition for the buyers database, a point of user access to the buyers database, or both. As shown, the server 11 is networked to programmable devices that serve as private information sources 21, programmable devices that serve as public information sources 23, agent programmable devices 25 (which may also serve as an information source), and buyer programmable devices 27 (which, again, may also serve as an information source). The server 11 may use any desired protocols and file formats to electronically communicate with these information sources and programmable devices deemed appropriate for the specifications of a particular implementation.

The server 11 interacts with these information sources and programmable devices to gather information into the buyers database and to distribute information from the buyers database in accordance with the programmable instructions provided to the server 11. To this end, the server 11 is programmed to perform the data gathering, data compilation, and database functionality that is described in further detail below. In performing data gathering, the server 11 is programmed to communicate with each of the information sources 21, 23, 25, 27 as appropriate to gather designated data for insertion into the buyers database. Some of the information sources, such as the agent devices 25 and the buyer devices 27, will initiate communication with the server 11 to provide data that is inserted into the buyers database. With some of the other information sources, such as the public and private information sources 21, 23, the server 11 will initiate communication with those sources in order to gather data for the buyers database, as described in greater detail below. The server 11 may also initiate communications with the agent devices 25 and the buyer devices 27 in order to gather data for the buyers database. At other times, the server 11 may initiate communications with the agent devices 25 and the buyer devices 27 as part of performing the programmed database functionality, such as responding to database queries, sending and receiving messages using the secure messaging system associated with the buyers database, and for other functionality as described in further detail below.

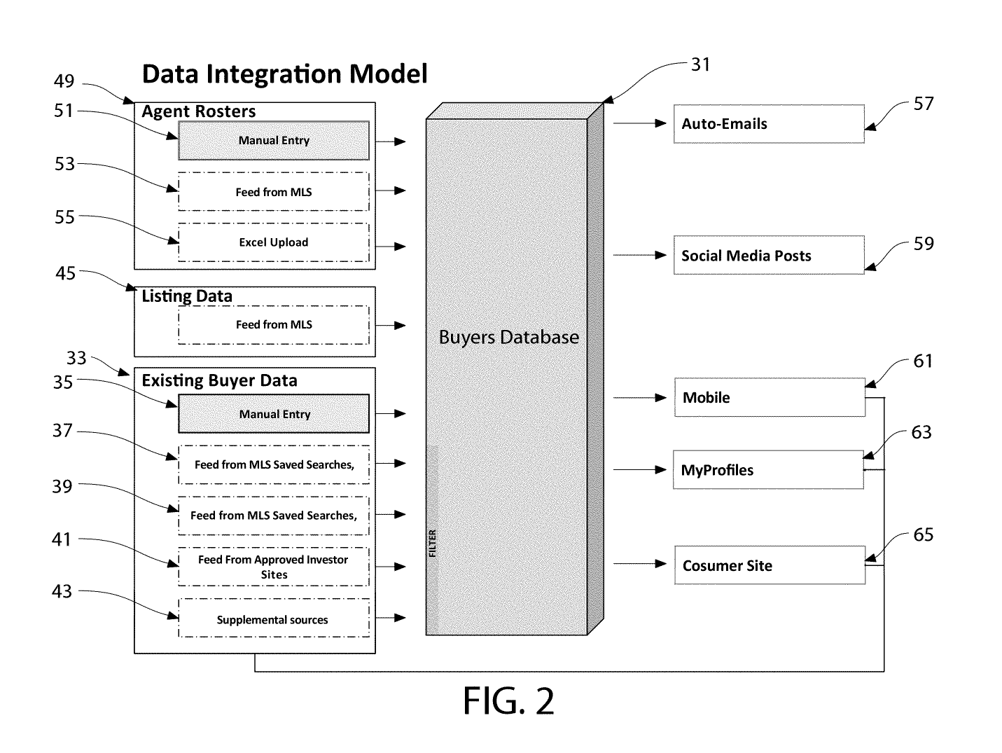

FIG. 2 illustrates the buyers database 31 along with sources of information. The buyers database 31 is a compilation of data from several disparate sources in order to provide the full range of features as described herein. Chief among the sources of information for the buyers database is information about each of the buyers 33. Several sources of information are used to gather data about each buyer. In certain embodiments, information about each buyer is first manually entered 35 into the buyers database, either by a buyers agent accessing the database through one of the agent devices 25, or by the buyer themselves accessing the database through one of the buyers devices 27. Access to the database in certain embodiments may be provided through applications configured to execute on programmable devices, such that the applications provide the user, whether as buyers agent, the buyer themselves, or otherwise, direct access to insert information about the buyer into the database. In other embodiments, the agent devices 25 and/or the buyer devices 27 may be programmed to serve as an interface for executing programming instructions, provided by the server 11, that grant the devices access to the buyers database. These types of programming instructions may be in the form of hyper-text markup language (HTML). Java® scripts, pearl scripts, Adobe® Flash® applications, and the like

The buyers database is entirely dynamic, with information about buyers, and information relating to property transactions, being regularly added and/or updated. Therefore, while a sequential process flow exists for a single buyer being entered into the buyers database, no sequential process flow exists when the buyers database is considered as a whole, containing information about a plurality of buyers, along with information in the buyers database about a plurality of agents and a plurality of available properties being offered for sale. In certain embodiments, the information about the agents and the available properties may be stored in a closely linked related database hosted on the server 11 or on another programmable, networked device in communication with the server 11, instead of being stored within the buyers database itself.

Information about a buyer or buyers may also be received from other sources. In the area of real property sales, certain multiple listing services (MLSs) retain information about buyers when the MLS database is queried by a user, and these certain MLSs may retain data about the buyers when such queries are performed. The server 11 maintaining the buyers database may be programmed to communicate with these MLSs to gather 37 this retained information and insert it into the buyers database. This may be performed periodically, on demand by either the MLS system or the server 11, or it may be done as part of other communication sessions that are initiated by one system or the other. For example, as described below, the server 11 may import property listing information from an MLS, and as part of the communications established to import the listing information, the server 11 may also request, or be provided, the retained information about the buyers for whom MLS database queries are made.

Data about buyers may also be imported 39 from contact relations management (CRM) software maintained by a selling agent or by a real estate brokerage. When an import of this type is performed, the server 11 may be programmed to allow data field mapping, such that information fields within the CRM software may be mapped directly to fields within the buyers database. While field mapping of this kind may take an effort to set-up, once it is set up, the import into the buyers database is anticipated to proceed quickly and efficiently.

Data about buyers may also be fed into the buyers database from other approved sources 41, such as through business partners, investors, advertisers, and the like. How this type of data is imported into the buyers database depends on the form it is in. For example, it may need to be manually entered in the event the data from the approved source is not in an electronic format, or if it is not in an electronic format that may be manipulated into a format that would be better imported using another method. Alternatively, if the data from the approved source is in an electronic format that is amenable to data field mapping, then the same import method that is used for importing data from CRM software may be used.

In certain embodiments, the buyer data will at least include, for each buyer included in the buyers database, buyer identification information, purchasing criteria of the buyer, and the buyer's agent. In instances where the identification information is at least a name and phone number for the buyer, then the server 11 may attempt to retrieve supplemental information for that buyer from additional public and/or private information sources 25, 27. If the buyer identification information does not include at least a full name and phone number for the buyer, the server 11 may optionally reject the entry for that buyer as being incomplete. However, the more information initially provided about each buyer included in the buyers database, the more success the server 11 will have implementing the additional features described below.

Once data for a buyer is imported into the buyers database, the server 11 is programmed to organize the buyers database by buyer, so that each buyer has a profile that may be easily and quickly retrieved from the buyers database. In certain embodiments, when a buyer is represented by an agent, the buyer's profile will also indicate the agent, and in some embodiments, the agent's manager. In certain embodiments, the buyers and agents may each be assigned a unique identifier to facilitate the server 11 managing the full scope of the data within the buyers database. The server 11 may be programmed to supplement the information in a buyer's profile by accessing both public and private information sources 43 to seek out supplemental information about a buyer. The public and/or private information sources may include sources such as social media web sites like Facebook®, Twitter®, and the like; from business networking web sites such as LinkedIn®, to the extent that public information is available to third parties; from credit reporting agencies such as Equifax, Experian, Transunion that maintain private databases; from telephone directories that are publicly accessible through the Internet; and from publicly available government records, such as property title records and the like. The type of public or private information source that may be accessed by the server 11 is practically unlimited, so long as the information is in a useable form and access for communications between the source and the server 11 can be satisfactorily negotiated.

Additional supplemental information for a buyer profile may be obtained from buyers themselves or from the buyers agents, as each uses and accesses the system. For example, supplemental information may be obtained about a buyer if queries of the database are performed by the buyer or on the buyer's behalf, even when a simple query is made by a buyer or agent accessing the buyer's profile from a computer or mobile device. This type of supplemental information may inform, alter, or supplement the purchasing criteria associated with each buyer. The purchasing criteria associated with a buyer may be refined, for example, by better identifying a range of property value, features of the property, or geographical location of the property. Geographical locations of interest to a buyer may be identified by, for example, receiving global positioning service (GPS) data from a buyer's or agent's mobile device when that buyer or agent is out and actively looking at properties, and is using a mobile app to access the server 11 and buyers database. Geographical location data may also enable the server 11 to identify intangibles associated with properties that appear important to a buyer having a profile in the buyers database, such as school districts, cities, neighborhoods, and the like.

Certain types of supplemental information may enable the server to induce purchasing criteria that appears likely to be important to a buyer. By way of example, information about a buyer's home ownership history, and specifically information about the homes owned by a buyer, can enable the server 11 to draw inferences about the type of home a buyer may be interested in. This may include the value of the home when purchased, as compared to the value of the home when sold, listed, or estimated, taking into account the cash equity position the buyer has been left with from each previous home sale. Such details may inform the value of property the buyer may consider. Some buyers may have no previous home ownership experience, which may lead the server 11 to look to other data to infer what value of property the buyer might consider. Other aspects of a buyer's history, when included in the supplemental information, may also help inform the scope of the property criteria for that buyer. By way of other examples, the number of rooms, bathrooms, and/or square footage each previously owned home included, and trends in each over time, could be used to draw inferences for the property criteria; in instances where the supplemental information indicates how many members are in the household (such as from U.S. census data), inferences for the size of a property may be drawn; the supplemental information may indicate the number of cars owned at the household, thus allowing an inference about garage space and/or parking availability for the purchasing criteria. These are just but a few examples of inferences that could be drawn from the supplemental information. Those of skill in the art will recognize that the supplemental data may be analyzed in many different ways, such that any number of inferences regarding the purchasing criteria for a particular buyer may be drawn from the data. Some inferences, however, are likely to be more relevant than others, and it is through regular data analysis over time that the relevancy of various inferences is expected to become apparent.

The purchasing criteria may also include a free form data entry field. In order to make the information entered into this field as useful as possible, an inference matching algorithm may be applied by the server 11 to the information provided in this free form entry field. In certain embodiments, the inference matching algorithm processes the data in the free form entry field by removing all punctuation marks, removing all article words, such as “the”, “a”, and “an”, removing all conjunctions words, such as “and” and “or”, and reducing other included terms to a base word, such as by reducing plural terms to their singular form and removing word tenses. Once the data in the free form entry field is initially processed, the inference matching algorithm assigns a list of synonyms to the remaining terms, and the resulting list of terns, including synonyms, is used for comparison during certain queries to a similarly processed free form entry field associated with properties that are included in a related properties database.

The server 11 may also gather data from private information sources 21 from within the financial services industry. To achieve this, the server 11 communicates electronically with a programmable device associated with a service within the financial services industry, such as a mortgage lender, a mortgage broker, or other similar service that evaluates a buyer's financial qualifications to purchase a property. Such private information sources 21 provide data regarding a buyer's ability to purchase a property, such as available cash for a down payment, credit worthiness for securing the purchase with a mortgage, whether a presently owned property needs to be sold before a transaction for a new property can be finalized, and the like. Using this information, the server 11 may assign a rating to each buyer in the buyers database. In order to provide a quick and concise indicator of a buyer's purchasing qualifications, the server 11 may assign a rating using a star system, with more stars being assigned to the more qualified buyers, and fewer stars being assigned to less qualified buyers, and no stars being assigned to buyers for whom purchasing qualification data is unavailable. It should be noted that a less qualified buyer is not necessarily one who cannot afford to purchase a property, rather the qualification rating is more of an indicator of the buyer's ability to purchase a home at the time the buyer is listed within a query result (see below).

The buyers database also includes information pertaining to properties offered for sale and those which have been sold. This information about properties offered for sale may be obtained by programming the server 11 to communicate 45 with a programmable device maintained by a Multiple Listing Service (MLS) or other similar property listing service. Such MLSs generally maintain a database which includes detailed information about properties being offered for sale, and oftentimes an MLS lists the status of a property, such as whether a property is still being offered for sale, whether it has a contract pending, or whether the contract has been finalized and completed. An MLS will also often include a history of the property being offered for sale, such as all the times the property was offered for sale and the sale terms the seller was asking for as part of the offer. In certain embodiments, the server 11 imports all the information available from the MLS into the buyers database, or into an associated properties database maintained by the server 11. The information about properties is also updated regularly, at intervals determined based at least upon specifications for the implementation and market conditions. For example, in a fast-moving market that is having many properties offered for sale and purchased over a relatively short period of time, the property information will need to be updated more regularly by having the server 11 more frequently communicate with the programmable device maintained by the MLS.

Many MLSs maintain information about properties using both a checklist of features, free form entry fields, and the asking price for the property, which are all analogous to what is described above with respect to the information about buyers that is included in the buyers database. The server gathers this information about the properties, and processes it in much the same way as it does the information about the buyers. Also, as mentioned above, the checklists of features for the buyers are intended to be substantially the same as the checklist of features many MLSs use for property listings. Therefore, a direct and one-to-one correspondence of checklist features will often exist between the buyers information included in the database and the property information. As discussed below, this correspondence facilitates identifying matches between buyers and properties. Like the free form entry fields for buyers, the free form entry field for properties is also processed to enable inference matching.

The buyers database also includes information about buyers agents and managers of the buyers agents. In certain embodiments, information about buyers agents and managers may be stored in an associated agents database, with data links being established between the agents database and the buyers database. Like the buyers information, the information about buyers agents and the managers may be manually entered 51, entered by importing from a spreadsheet or CRM data 55, and/or it may be obtained from the MLS data 53, which generally includes information about agents who are acting on behalf of property sellers, who also sometimes act as buyers agents. The information collected about the buyers agents and the managers, in certain embodiments, is basic contact information. The server 11 also provides an identifier for the agents and managers, to distinguish then and to enable different levels of access, and identifies which agents are associated with a particular manager. For example, in certain embodiments an agent may only be given access to buyers who are associated with that agent, and a manager may be given access to all buyers associated with agents who are in turn associated with that manager. In other embodiments, unrepresented buyers and/or agents are never provided with direct contact information for other, non-associated buyers, whereas it may be desirable to give managers direct contact information for all buyers associated with agents who are being managed by that manager.

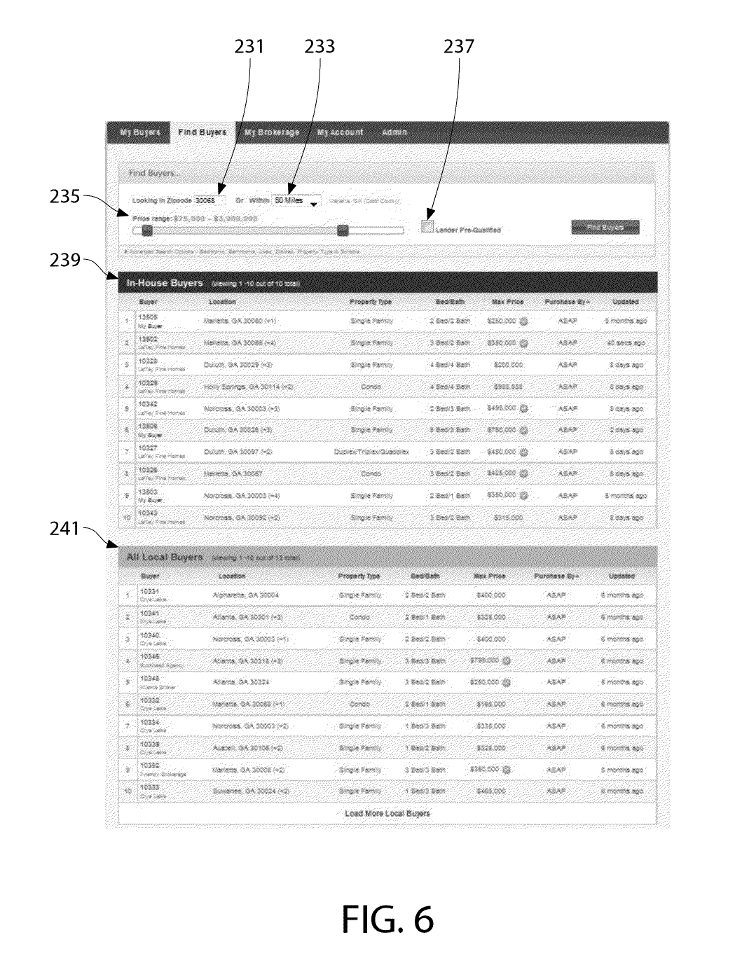

When a new property is added to the buyers database, or information about a property is updated, the server 11 may be configured to automatically run queries and transmit query results via email 57, or other forms of electronic, communication. The server 11 may similarly be configured to automatically run queries and transmit query results when a new buyer is added to the buyers database or information about a buyer is updated. In performing these automatic queries, the server 11 seeks to match the new property or new buyer with one or more buyers or properties, respectively, that are already included in the database. The matching process produces query results by one-to-one matching buyer information and purchasing, criteria with property information. For some of the data, one-to-one matching is not possible, for example, with the free form entry field, and so the server applies the inference matching to the free form entry field as described above in an attempt to increase the quality of the matches identified. A query may then use the checkbox features for both buyers and properties and the inference matching algorithm to assemble query results of buyers that match a property and/or properties that match a buyer. An example of query results is shown in FIG. 6, and the query results may be transmitted directly to an agent, a manager, or an unrepresented buyer directly. In certain embodiments, an email may be transmitted that indicates the availability of the query results at the next time the agent, manager or unrepresented buyer accesses the server 11 from a remote programmable device.

The server may also be programmed to automatically and periodically generate query results for matching, based on preselected criteria for a query. In some embodiments, the criteria may be for a geographical location, such as a neighborhood or school district, with the query results being generated once per week or month, or according to any other desired period. Such automatic query results may serve as hot sheets to buyers agents, listing, agents, and/or managers of the agents, helping to inform them where sales efforts should be focused, and whether those efforts are best focused on finding new sellers interested in selling their property, or on buyers who are interested in purchasing property.

The server 11 is programmed to accept queries formed on and submitted by remote devices. The queries may be generated by a user accessing the server 11 and the buyers database through a programmable device displaying an appropriate graphical user interface, or in certain embodiments queries may he generated programmatically by accessing the server 11 through a programming interface and submitting an appropriately formed query statement from a programmable device. The details of a programming interface and the formation of query statements are left to the specifications for a desired implementation, and developing such details are well within the capabilities of one of ordinary skill in the art. Upon receipt of a query from a programmable device, the server 11 generates query results and transmits those results to the programmable device. In embodiments in which automatic queries are programmed and query results generated therefrom, the server 11 transmits the query results to a programmable device, through email, and/or through any other electronic communication channel, in accordance with the programming.

Queries and the query results that are returned may serve many purposes, and any of the queries discussed herein may be formed by a user of a programmable device accessing the server 11, or they may be formed by programming of the server 11 to be automatically run at the occurrence of a desired trigger (e.g., adding a new buyer, adding a new property, updating a buyer or a property, daily, weekly, monthly, etc.). As already discussed, the query results may serve to identify potential buyers for a particular property, or for properties within a geographical region, or for a property or properties having any other features that are specified within the database. This type of results may be generated by forming a query based on the features associated with the property or properties. A query may be further limited to show, in real time, buyers in the nearby geographical region of the property who have purchasing criteria that matches, at least to an extent, with the features of the property, and to the extent that buyers have programmable devices actively connected to the server to provide the server with present geographical location data.

In certain embodiments, queries may be used by buyers and sellers of properties as an aid to establishing market valuation of the property. For buyers, this may aid in the purchase of property and determining how much the present market values the property. With knowledge about how the present market values the property, the buyer is better empowered to make an offer to purchase the property at or near the present market value. This is in contrast to how many property transactions, especially those for real property, are conducted in the prior art, where property valuation is determined by examining similar transactions from the past, typically those from within about the past six months. It is anticipated that by combining the valuation methods of the prior art, i.e. past similar transactions, with data from the buyers database, which is a measure of present buyer demand, an improved present, real-time valuation of the property may be determined.

Sellers of property may benefit from such improved present, real-time valuation by having a better understanding of present market conditions in order to set an asking price for the property being sold. This better understanding for sellers may lead to the ability to sell a property using dynamic list pricing, which may change the listing price for the property from day to day, week to week, or even month to month, all based on current market conditions, including buyer demand.

The server 11 may also be programmed to post to agents or managers social media accounts 59, either automatically upon the occurrence of certain events, such as adding or updating associated buyer information, or upon request by the agent or manager. Social media posts may be a short blurb, in which the identification of the buyer is riot revealed, but details of the buyer's purchasing criteria are.

As indicated above, access to the server 11, and the buyers database 31, may be granted to any programmable device 61, such as a mobile phone, a tablet, or desktop computer, with the level of contact being: determined by one or more of the confirmed identity of the user operating the programmable devices, or the confirmed identity of the device itself. Techniques to confirm identity of a user and/or programmable device are well known in the art, and so the details of how to confirm the identity and determine the level of access that should be granted are left to the skilled artisan for implementation.

Buyers, agents, and managers are given access to their own profiles 63 by the server 11. In certain embodiments, the server 11 may only grant represented buyers access to view, but not to edit, their own profile. Non-represented buyers may be given full viewing and editing access to their own profile. The server 11 may grant agents viewing and editing access to their own profile and to the profiles of associated buyers. The server 11 may grant managers viewing and editing access to their own profile, and in some embodiments, managers may be granted viewing and editing access to the profiles of associated agents and their associated buyers. In other embodiments, it may be desirable to have the server 11 grant managers only viewing access to the profiles of associated agents and their associated buyers.

In certain embodiments, the server 11 may grant non-identifiable users (i.e., the general public) limited access to the buyers database 65. In such embodiments, access may be limited to information that does not directly identify a buyer, and/or and agent, and/or a manager, and/or a property, and to use of the message communication system programmed as part of the database management features of the server 11, so that a non-identifiable user may initiate contact with unrepresented buyers, and/or agents, and/or managers, and/or property sellers through the limited access to the server 11. The buyer, agent, manager, or property seller is then given the option to contact the non-identifiable user without exposing personal contact information.

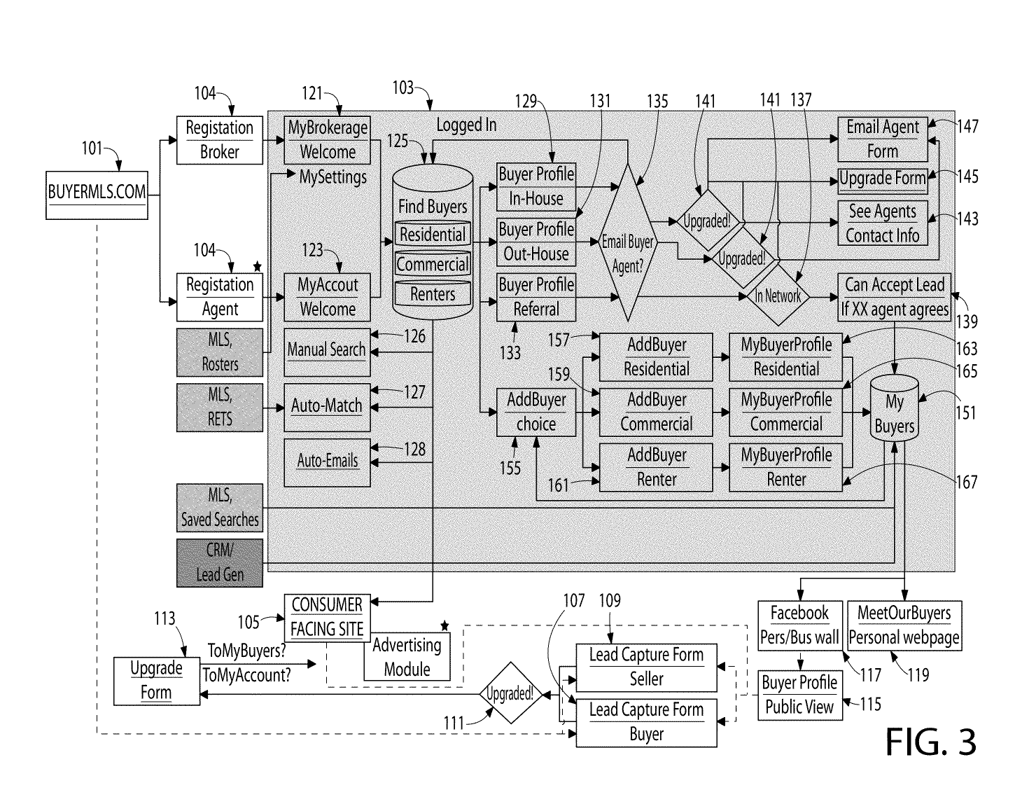

Turning to FIG. 3, the process flow of one embodiment of the configuration and programming for the server 11 is shown. The server maintains a public-facing web site 101, through which registered agents, registered managers/brokers, and registered, unrepresented buyers and/or sellers may access the secure area 103 of the server. Brokers and agents who are not presently registered may be offered an opportunity to register 104, by providing appropriate credentials, such as a license identification number or an access code previously issued for purposes of establishing a registered account.

The server also maintains a public portal 105 which enables non-registered users to have limited access to the buyers database. The public portal 105 is configured to capture identifying information for both interested property buyers 107 and interested property sellers 109, to the extend they are interested in providing identifying information, which may be any or all of a name, an email address, a phone number, a mailing address, and the like. The server also presents these interested buyers and sellers with an opportunity 111 to become a registered user of the database, and for those who so choose, presents a form to upgrade and pay for the enhanced service. In the absence of upgrading the service 111, unregistered users are granted limited access 115 to the database, allowing them to conduct queries and view limited query results 115. As indicated above, the limited results may allow the unregistered user to view buyer criteria, or property criteria, depending upon the type of query, but not view any identifying contact information for the buyer, seller, or a representing agent. In such embodiments, the unregistered user may use the messaging system the server is programmed with in order to contact an agent, buyer, or seller.

Outside of the public portal 105, the server may also communicate limited information about individual buyer's purchasing criteria to social media websites 117, and the server may also publish buyer sheets 119, which are electronic documents containing limited information about individual buyer's purchasing criteria. These published buyer sheets may be copied by agents and managers for republication elsewhere, such as in print, via newsletters, or in other electronic forums.

A registered broker accessing the server is presented with a page of information 121 summarizing associated agents and buyers associated with those agents, and any recent activity of those agents or buyers. In certain embodiments, this page of information is highly customizable, so that a broker may display on the page any information from the database to which that broker is granted access. The information may include agent rosters, MLS information associated with agents associated with the broker, recently added buyers, buyers who have been in the database for a predetermined amount of time who have not made a purchase, and practically any information that can be teased out of the database by an appropriately formed query of the server.

A registered agent accessing the server is likewise presented with a page of information 123 summarizing buyers associated with that agent. Again, in certain embodiments, this page of information is highly customizable, so that an agent may display on the page any information from the database to which that agent is granted access. The information may include a list of associated buyers, MLS information associated with the agent, recently added buyers, buyers who have been in the database for a predetermined amount of time who have not made a purchase, and practically any information that can be teased out of the database by an appropriately formed query of the server.

From the initial summary landing page, registered agents, registered brokers, and unregistered users may further access the buyers database by viewing query results 125, which are the result of either manual queries 126, submitted by the user, queries that are automatically run 127 as part of the database management routines the server performs, as have already been described, or queries that result from automatic email notifications 128 sent out by the server, also as already described. Depending upon the embodiment, the query results may be directed to a specific type of property buyer, a residential buyer, a commercial buyer, a residential renter, or a commercial lessee. For purposes of the buyers database and the server, renters and lessees of property are categorized, as buyers, even though the transactions that take place for renters and lessees are not purchase contracts—they are contracts of value, there is often a substantial relationship and/or similarity to purchase contracts, and the markets for purchases and rentals/leases frequently overlap. Markets for property other than real property may have many of these similarities, and so no distinction need be made for purposes of the operation of the server and management of the database.

The query results are transmitted 125 to the user (e.g., the agent, the broker, or the unregistered user), with the query results not including any contact or identifying information of the buyers included in the results. The server permits the broker to select a buyer and view the full agent contact information and the buyer profile 129. Again, certain embodiments may permit the broker to view buyer contact information, and others may permit the broker to edit the buyer profile. The server also permits agents associated with the same broker to select a buyer and view the full agent contact information 143, but not the buyer contact information or any directly identifying information within the buyer's profile. In certain embodiments, the server may not permit agents and/or brokers who have no association to select a buyer and view the full agent contact information 131—they may also not be permitted to view the buyer contact information or any directly identifying information within the buyer's profile. In instances where an agent's contact information is not viewable, the option is presented to use the messaging system 135 to contact the agent representing the buyer and send that agent a message 147. In the event that the user is unregistered 141 with the server, whether an unregistered agent, broker, buyer, or seller, the user is presented with an opportunity to upgrade to become a registered user 145.

The unregistered user who is a buyer or a seller is treated as a potential referral 133 by the server. This type of user may also be presented with an option to upgrade to become a registered user 145. In addition, information collected from this type of user, which may be required to access the server initially, may be forwarded to a registered agent or broker as a referral. This user may then be added to the buyers database, and the registered agent accepting the referral becomes associated with this newly added buyer within the buyers database 151.

In certain embodiments, one registered agent may make a referral to a second registered agent. This may happen for many reasons, among which include the first agent not being in the geographical location indicated by the buyer's purchasing criteria. In this instance, the second agent may contact the first agent through the massaging system 135, and the first agent may be presented with an option to approve 139 associating the buyer with the second agent. Upon approval the buyer is associated with the second agent within the buyers database 151.

Agents and brokers as users are also presented with the option to add a buyer or buyers 155 when accessing the server. Different pages may be presented to these users which give the option of which type of buyer they wish to add, whether for a commercial property 157, a residential property 159, or as a renter/lessee 161. The type of buyer generally will result in a different set of parameters being presented to the user during the process of adding the buyer to the database, so that for each type of buyer, a different page, showing different input options, is presented to the user, one for each of a buyer of a commercial property 163, a buyer of a residential property 165, and a ‘buyer’ who is a renter/lessee 167. Once the buyer information is entered manually, then that buyer is associated with the user creating, the buyer profile.

As discussed earlier, agent and broker users are presented with options to import buyer information from MLS data 171 and from CRM or lead generation data 173. Those buyer profiles that are created from such imports are associated with an agent just the same as a manually entered buyer profile. Moreover, the server processes all buyer profiles the same, as described above, to obtain more information about each buyer from other sources and draws inferences about the buyer and the buyer's purchasing criteria so that better matches can be made with properties being offered for sale.

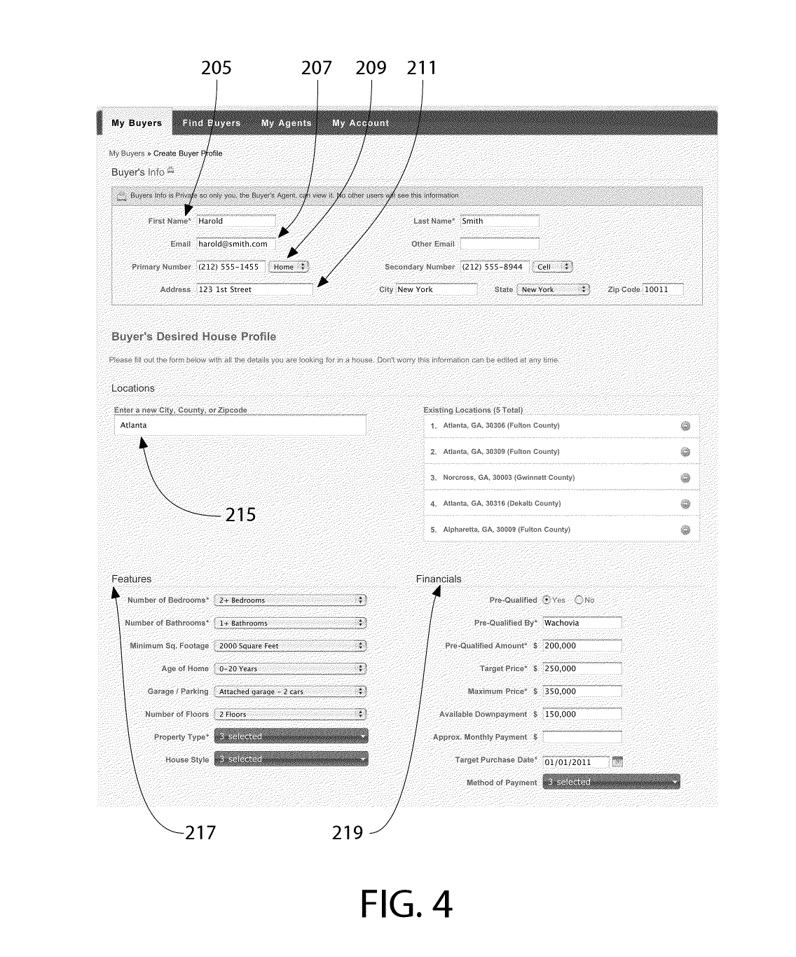

A manual entry form for buyer's information is shown in FIG. 4. In certain embodiments, this form is presented to a user by the server when a new buyer is to be entered into the database. On this form, spaces are provided for a buyer's contact information, including first and last names 205, email addresses 207, phone numbers 209, and present mailing or home address 211. As a reminder to the user inputting the personal contact information for the buyer, the form includes indicia that all this information remains private, viewable only to the buyer's agent. The remainder of the buyer's information will become part of the buyer's profile that is viewable to all others accessing the system. The user may be provided with a field 215 to add a geographical location in which the buyer is interested in looking for property. Multiple geographical locations may be added, and although the field shown requests city, county, or zip code information, other geographical identifiers may be requested in certain embodiments, such as neighborhoods, voting districts, and the like. These geographical locations form part of the buyer's purchasing criteria. A number of specific fields 217 are provided for the user to indicate the buyer's purchasing criteria for the property. In the form shown, purchasing criteria for a residential home is shown. As indicated above, these purchasing criteria are substantially the same as those typically used by MLSs. Fields 219 for financial information about the buyer are also provided. These include whether the buyer has been prequalified by a business in the financial services sector, a space to indicate what business provided the prequalification, and the amount of the prequalification. Also included in the fields 219 for financial information are the target price for a property purchase, a maximum price the buyer is willing to pay, the amount of cash or cash equivalents the buyer has available, the target monthly payment, assuming one is provided, and the target purchase date.

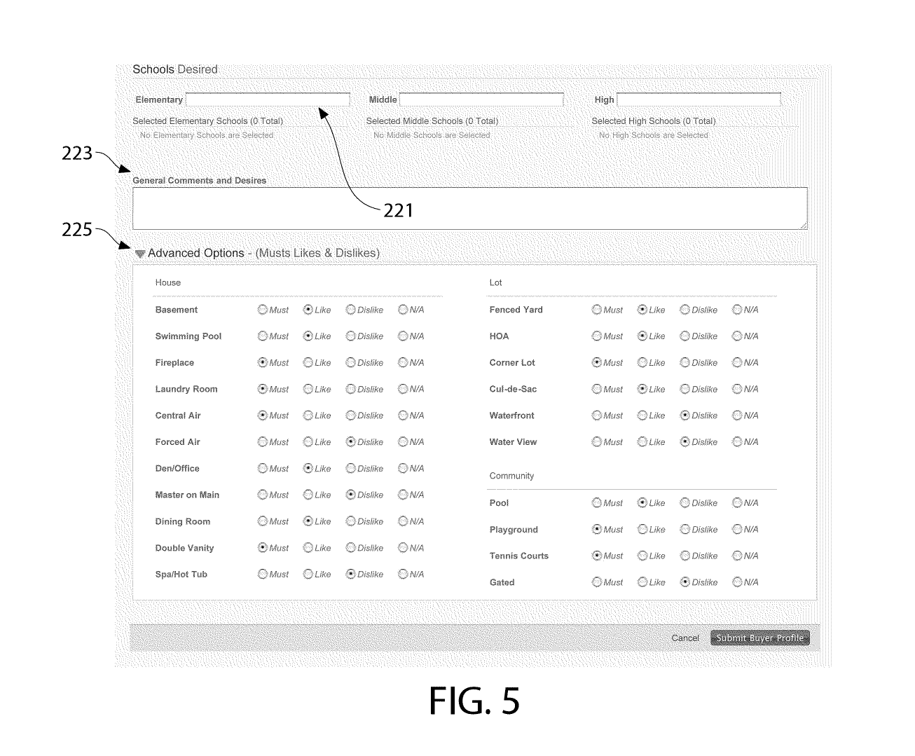

A second page of the manual entry form is shown in FIG. 5. This page provides spaces 221 for the entry of preferred schools, and certain embodiments allow entry of more than one school at each education level. A free form entry field 223 is also provided so that the user may enter details that are important to buyer, but for which there is not otherwise a predefined field for the entry of such details. As described above, this free form entry field 223 is processed in order to draw inferences about the buyer's purchasing criteria. Advanced option fields 225 are also provided on this form, so that the user may indicate the level of the buyer's preference for such property details as a basement, swimming pool, etc., as indicated on the form. These features are identified by a must/like/dislike choices so that a buyer's purchasing criteria may better indicate which features are most important, and which features are considered more optional.

A summary page presented by the server to a registered agent is shown in FIG. 6. This page shows the registered agent those buyers who are within the agent's working zip code 231, which may or may not be the same as the office location from which the agent works, and it also provides the option for the registered agent to show buyers within a specified radius of a geographical location 233. The agent may also adjust the price range 235 to adjust the list of buyers shown based on overlap between the purchasing criteria of the buyers, and the price ranges included therein, and the range selected by the agent. Another option for the agent is to select only buyers who have been prequalified for a purchase 237. These fields may be auto filled based on criteria saved from a previous session, or saved with an agent's profile, and they may be adjusted by the agent, with the agent being able to update the query results on demand. The query results show two separate lists, the first list 239 including buyers associated with one or more other agents, these other agents sharing a common broker association with the agent doing a search, and the second list 241 including buyers who have no common association with the agent performing the search. The agent may view the more detailed purchasing criteria of any of the buyers in either of the lists. For buyers in the first list 239, the agent may also view the contact information for the buyer's agent, and for the buyers in the second list 241, the agent is offered the option to contact the buyer's agent through the secure messaging system associated with the buyers database.

Each list 239, 241 shown to the agent includes, for each buyer a buyer identifier, an agent, office, or broker identifier, the location of interest (and whether there are additional locations of interest beyond the single location shown in the list), the type of property the buyer is looking for, the number of bedrooms and bathrooms for the house, the maximum price, the target purchase date, and an indicator of how long ago the buyer information was last updated.

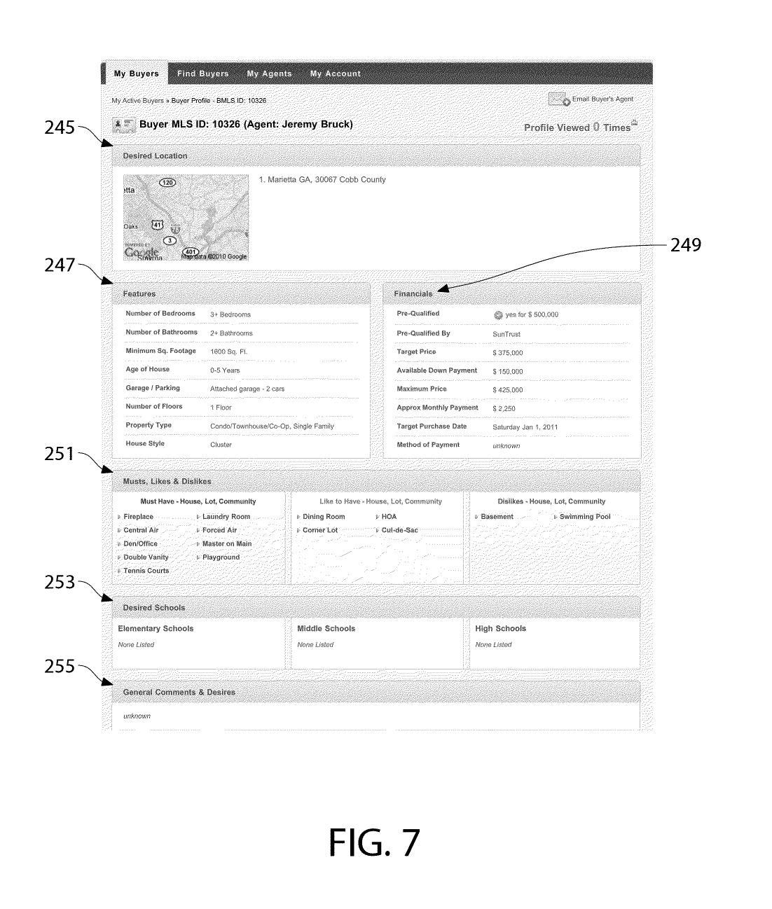

The detail profile view for a buyer not associated with an agent or broker viewing the profile is shown in FIG. 7. This profile page shows the same information entered on the forms of FIGS. 4 and 5, absent the personal identification information for the buyer. The viewing agent is shown the buyer database ID and the listing agent's name, along with the desired geographical location 245 for the buyer, the basic features 247 of the property the buyer seeks, and the basic financial information 249 for the buyer, including whether the buyer has been prequalified for a purchase, who performed the prequalification, and the prequalified amount. The additional detailed features 251 indicated for the buyer by must/like/dislike selection are grouped by the selection choice, school preferences 253, if any, are listed near the bottom, and information that was placed in the free form entry field 255, if any is listed at the bottom of the profile view. The viewing agent is also not presented with an opportunity to edit the profile. To aid a viewing agent in determining how active, or realistic, this buyer's purchasing criteria may be, the number of times this buyer's profile has been viewed is shown at the top of the detail profile view.

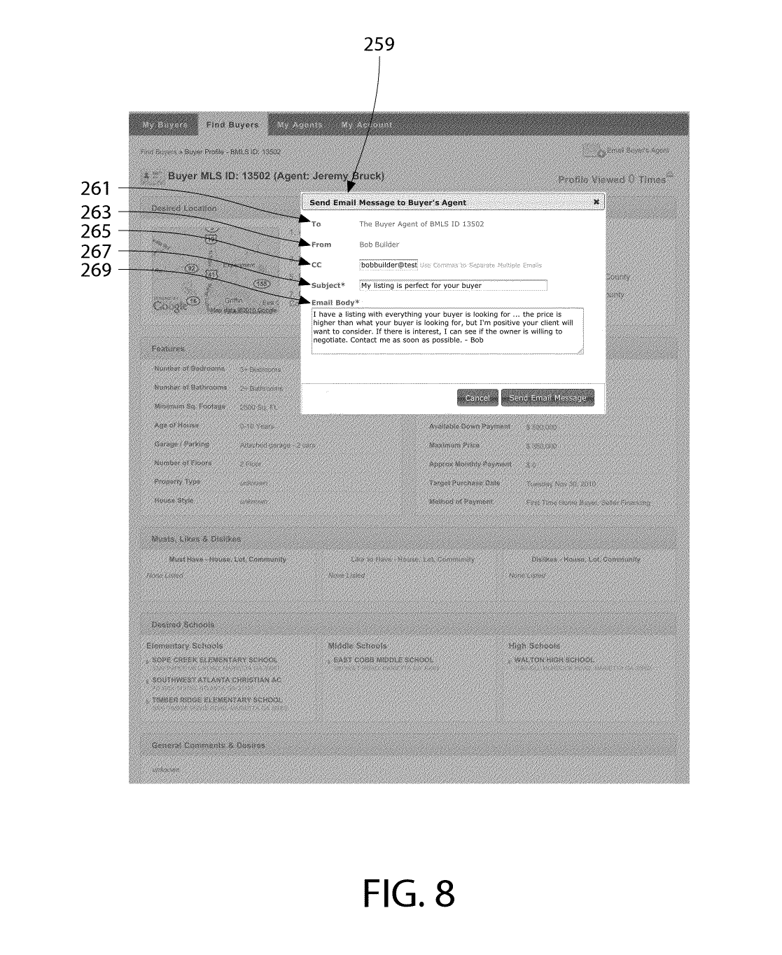

An example of a message pane 259 overlaying a detail profile view is shown in FIG. 8. The secure messaging system associated with the buyers database automatically fills in the field for the agent to whom the message is being sent 261 and the field indicating who is sending the message 263. The sender is permitted to fill in the cc: field 265 to send the message to one or more email addresses, thereby creating a record of the communication and informing others about it. The sender is permitted to fill in the subject field 367, and there is a space for the message body 269.

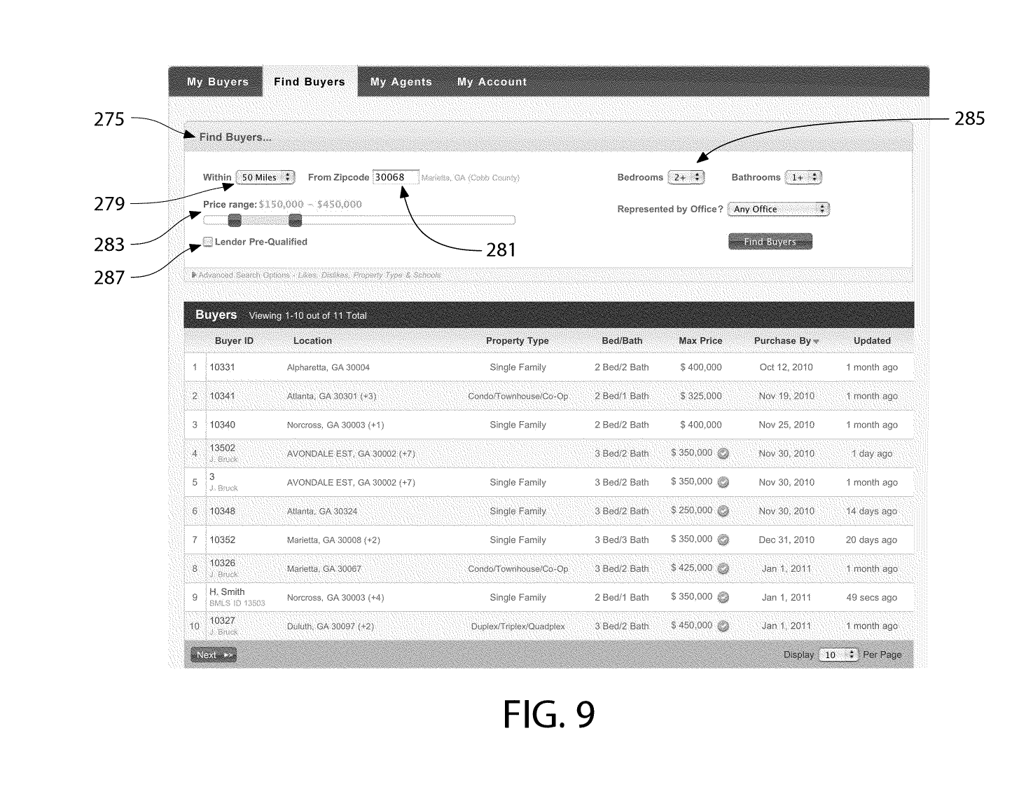

A query 275 and query results 277 are shown in FIG. 9. This query 275 is based on simple criteria, including a geographical location 279, a defined radius 281 around that geographical location, a price range 283, and basic bedroom and bathroom information 285 for buyers seeking a property. Although unused in the query shown, a simple query also provides the opportunity to filter based on whether the buyers are prequalified 287. The query results 277, appear the same as the lists shown in FIG. 6.

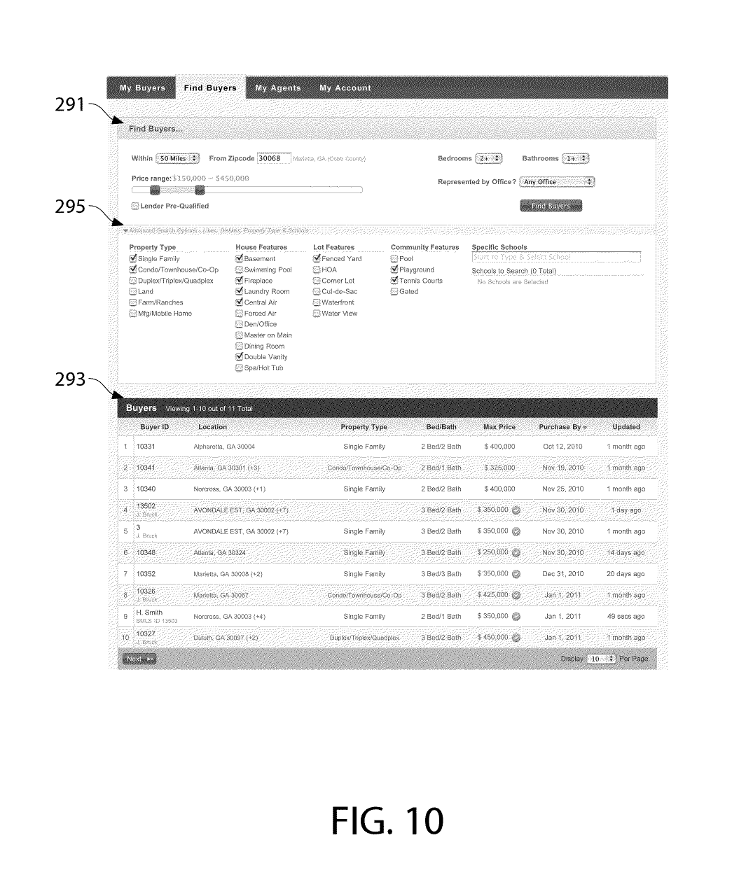

FIG. 10 shows a query 291 having the same simple criteria as the query of FIG. 9. In addition, the query 291 of FIG. 10 includes advanced search options 295 to serve as an additional filter for the query results 293. The advanced search options 295 permit the user to select specific property features for the search, and the buyers are matched to these specific property features based on the must/like/dislike criteria associated with each of these features in the buyer's purchasing criteria.

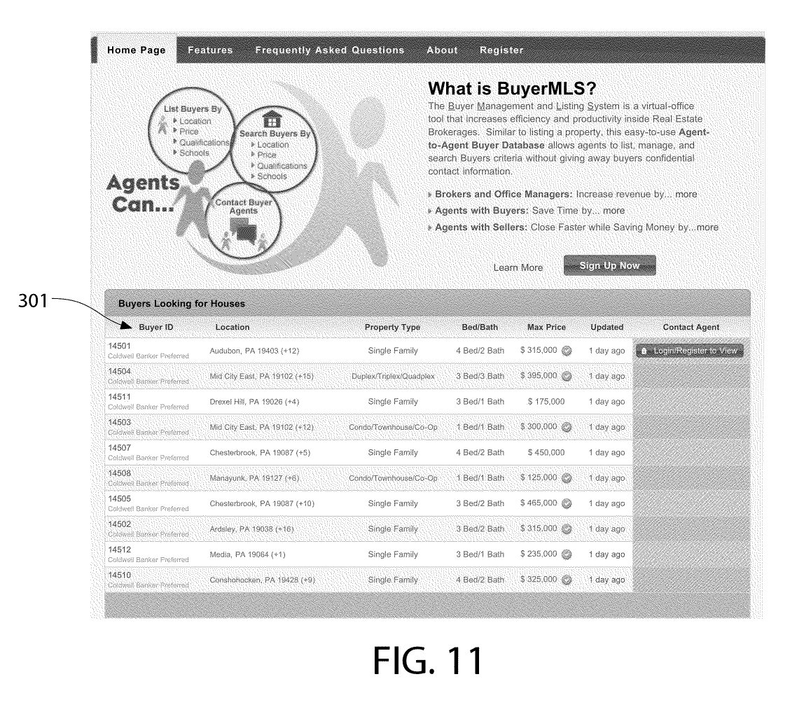

A splash page showing basic query results 301 to an unregistered user is shown in FIG. 11. The query results 301 here show some basic buyer purchasing criteria, such as the geographical area of interest, the property type of interest, the number of bedrooms and bathrooms sought by the buyer for a home, the maximum price for the buyer, and how long ago the buyer profile was last updated. The buyer's agent name is not shown, and in place of the buyer's agent name under the buyer identification number, the name of the brokerage is listed, the brokerage being associated with the buyer's agent.

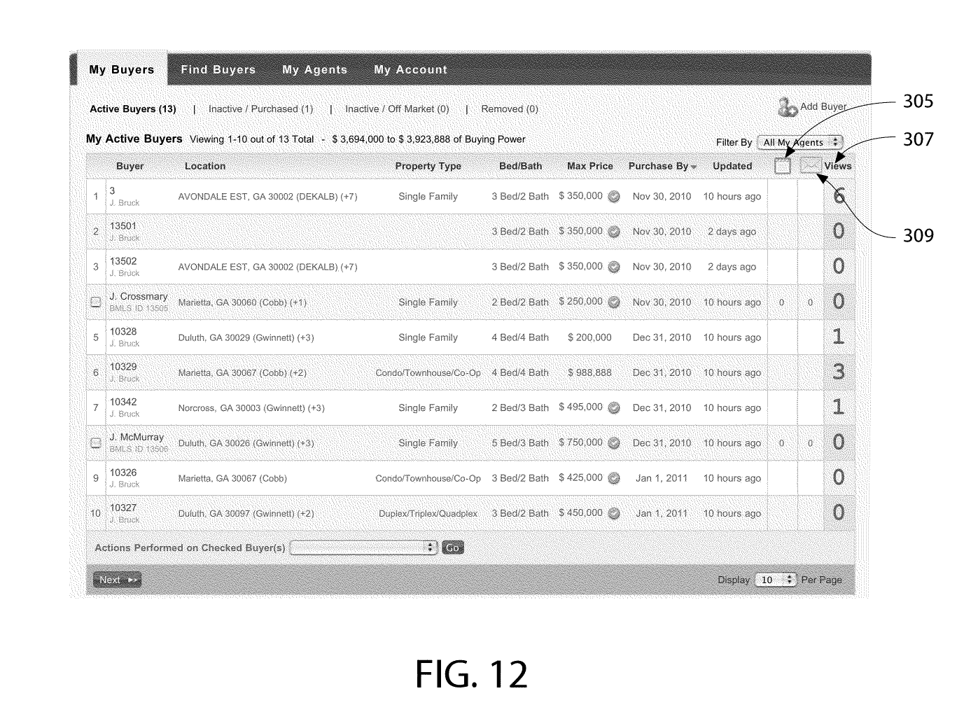

Query results 303 showing a listing of the activity of buyers is shown in FIG. 12. In this listing, an agent accessing the server is able to view buyers associated with that agent. This listing includes three additional columns as compared to some other listings discussed above. The first column 305 is an indicator of notes made by the agent about the buyer. In certain embodiments, the agent may create such notes, and associate the notes with a particular buyer. In addition, some embodiments may allow the agent and the buyer both to make notes in the database, about properties or otherwise, thereby enabling a record to be created about the property search while it is ongoing. The second column 307 indicates whether the agent has received messages concerning the buyer, and the third column 309 indicates how many times others have viewed the buyer's detailed profile.

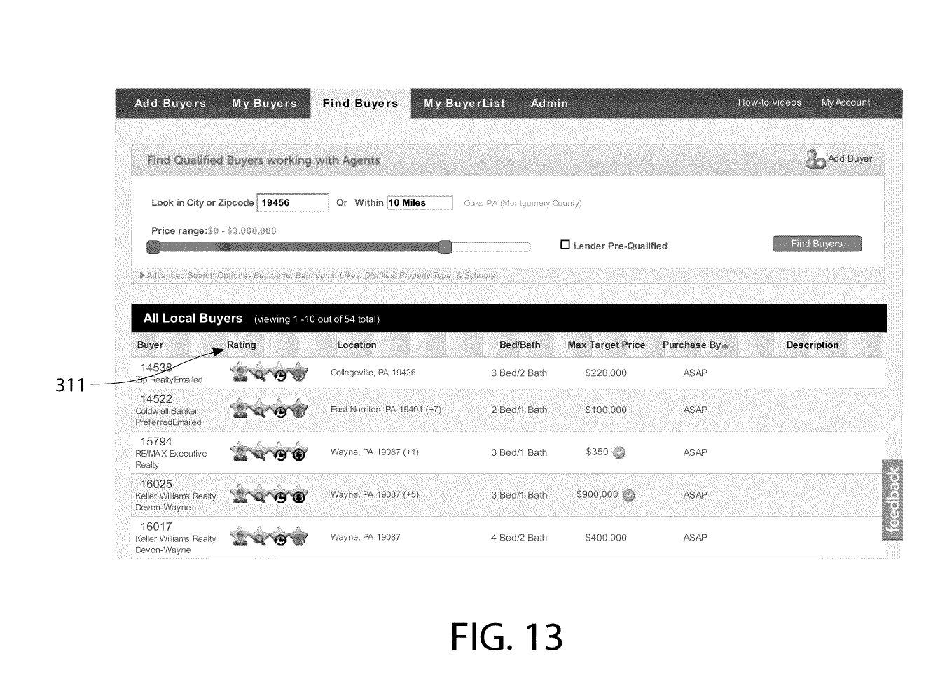

Another example of query results is shown in FIG. 13. This query results shows the prequalification of the listed buyers based on a star rating system 311, with more stars being indicative of how qualified the buyer is to purchase property at the time the query results are generated. As indicated above, the prequalification rating may change for a buyer at any time due to the buyer's particular circumstances, such as if the buyer is presently the owner of another property that needs to sell before the buyer can purchase another property. As is known to those skilled in the art, many other factors may alter the buyer's prequalification rating.

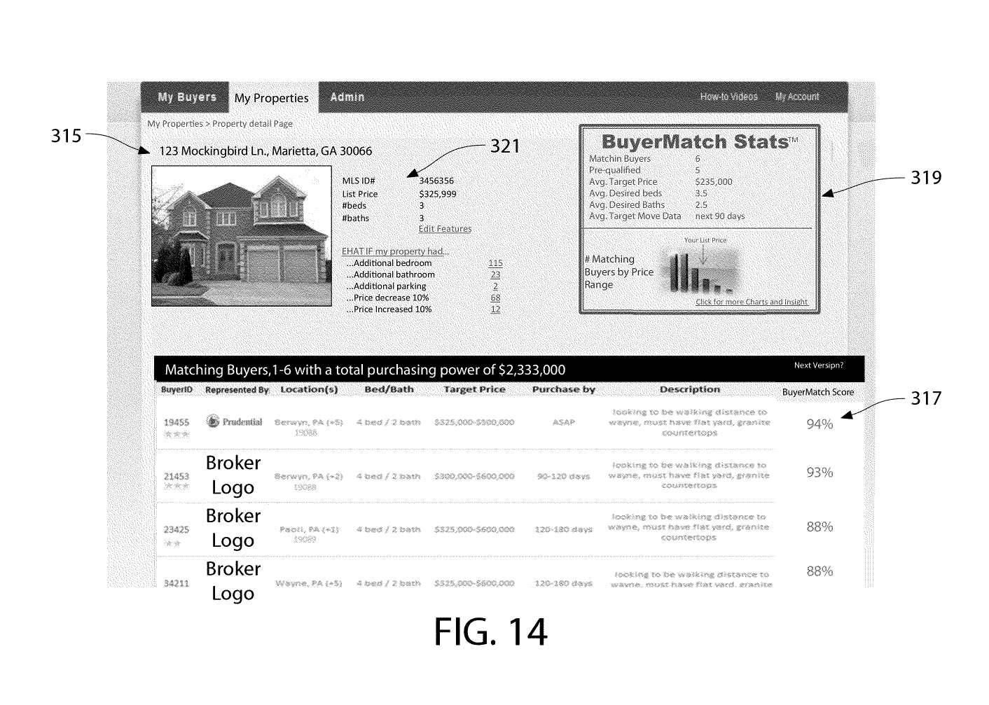

Yet another example of query results is shown in FIG. 14. This query results shows a listing of buyers having purchasing criteria that overlaps with the features of a particular property 315. The listing shows, as a percentage score, how well matched 317 each buyer is to the property, where 100% would be complete overlap of all purchasing criteria for a buyer and the property. The query results also shows some statistics 319 of the matched buyers, to give the user who performed the search a better idea of the quality of the buyers in the market for the property. The very results also presents the user with some hypothetical scenarios 321, winch show the user how many buyer matches the property might have if certain types of alterations were made to the property. These hypothetical scenarios can give the property owner a better idea of the overall market, and may serve as motivations to make improvements to the property.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should he construed broadly as set forth in the appended claims.

1. A method for managing a database of buyers, the method comprising:
storing, at a server, a buyers database comprising data related to a plurality of buyers, the data including, for each of the plurality of buyers, buyer identification information for the buyer, purchasing criteria of the buyer, and buyer agent information associated with the buyer;
retrieving, by the server, supplemental information horn an information source about each buyer based upon the buyer identification information;
storing, by the server, the supplemental information about each buyer in the database; and
receiving, at the server, a first query of the buyers database from a first remote device, wherein the first query returns first query results including the purchasing criteria and buyer agent information for each buyer included in the first query results; and
transmitting the first query results to the first remote device.

2. The method of claim 1, wherein the buyer identification information is excluded from the first query results.

3. The method of claim 1, further comprising,
receiving, at the server, a second query of the buyers database from a second remote device, wherein the second remote device is associated with a managing user, the managing user identified by the server as managing a first plurality of agents, and the second query returns second query results including the buyer identification information, the purchasing, criteria, and the buyer agent information for each buyer included in the second query results which is associated with one of the first plurality of agents;
transmitting the second query results from the server to the second remote device.

4. The method of claim 1, further comprising:
storing, at the server, a property listings database comprising data related to a plurality of properties for sale, the data including, for each of the plurality of properties, property features.

5. The method of claim 4, wherein the purchasing criteria of the buyer and the property features include a plurality of overlapping categorizations.

6. The method of claim 4, further comprising:
automatically matching, by the server, one or more of the buyers with one or more of the properties; and
providing match results from the server to one of a respective buyer agent or a respective seller agent concerning the matched one or more buyers and the one or more properties.

7. The method of claim 4, further comprising:
matching, by the server, one or more of the buyers with one or more of the properties; and
estimating, by the server, a market value of the one or more matched properties based upon the purchasing criteria of the one or more matched buyers.

8. The method of claim 1, wherein the data in the buyers database further comprises buyer purchasing qualifications for each buyer, and the first query results further include the buyer purchasing qualifications for each buyer.

9. The method of claim 8, further comprising assigning a buyer qualification rating, by the server, to each buyer within the buyers database based on buyer purchasing qualifications included in the database for each buyer, wherein the first query results further include the buyer qualification rating for each buyer.

10. The method of claim 9, wherein the buyer qualification rating is further based on the supplemental information about each buyer.

11. The method of claim 1, further comprising:
generating, by the server, a second query of the buyers database, wherein the second query returns second query results including the purchasing criteria and the buyer agent information for one or more of the buyers entered into the buyers database within a recent predetermined period; and
transmitting the second query results from the server to agents for sellers of properties.

12. The method of claim 1, wherein the first query results include a plurality of buyers grouped by purchasing criteria having a common geographical identifier.

13. The method of claim 12, the common geographical identifier refers to one or more of a neighborhood, a community, a subdivision, a school district, and a city.

14. The method of claim 1, further comprising receiving, by the server, geographical location data from a plurality of remote devices, each associated with one of a plurality of active buyers in the database, wherein the first query results include one or more of the plurality of active buyers grouped by proximity to a geographical location identified in the first query.

15. The method of claim 14, wherein the geographical location is a location of a property offered for sale.

16. The method of claim 1, wherein the purchasing criteria includes a plurality of predetermined categorizations and at least one free form entry field.

17. The method of claim 16, further comprising, applying an inference matching algorithm to the at least one free form entry field as part of returning the first query results.

18. The method of claim 1, wherein the supplemental information includes property ownership history associated with each buyer.

19. The method of claim 18, the method further comprising applying a trend analysis algorithm to the ownership history as part of returning the first query results.

20.-72. (canceled)

73. A network comprising at least one server configured to execute non-transitory computer executable code, the code instructing the server to:
store a buyers database comprising data related to a plurality of buyers, the data including, for each of the plurality of buyers, buyer identification information for the buyer, purchasing criteria of the buyer, and buyer agent information associated with the buyer;
retrieve supplemental information from an information source about each buyer based upon the buyer identification information;
store the supplemental information about each buyer in the database;
a first query of the buyers database from a first remote device, wherein the first query returns first query results including the purchasing criteria and buyer agent information for each buyer included in the first query results; and
transmit the first query results to the first remote device.

74. The network of claim 73, wherein the buyer identification information is excluded from the first query results.

75. The method of claim 73, wherein the supplemental information includes property ownership history associated with each buyer.

76. The method of claim 75, wherein the code further instructs the server to apply a trend analysis algorithm to the ownership history as part of returning the first query results.

77. The network of claim 73, the code further instructing the server to:
receive a second query of the buyers database from a second remote device, wherein the second remote device is associated with a managing user, the managing user identified by the server as managing a first plurality of agents, and the second query returns second query results including the buyer identification information, the purchasing criteria, and the buyer agent information for each buyer included in the second query results which is associated with one of the first plurality of agents;
transmitting the second query results from the server to the second remote device.

78. The network of claim 73, the code further instructing the server to:
store a property listings database comprising data related to a plurality of properties for sale, the data including, for each of the plurality of properties, property features.

79. The network of claim 78, wherein the purchasing criteria of the buyer and the property features include a plurality of overlapping categorizations.

80. The network of claim 78, the code further instructing the server to:
automatically match one or more of the buyers with one or more of the properties; and
provide match results to one of a respective buyer agent or a respective seller agent concerning the matched one or more buyers and the one or more properties.

81. The network of claim 78, the code further instructing the server to:
match one or more of the buyers with one or more of the properties; and
estimate a market value of the one or more matched properties based upon the purchasing criteria of the one or more matched buyers.

82. The network of claim 73, wherein the data in the buyers database further comprises buyer purchasing qualifications for each buyer, and the first query results further include the buyer purchasing qualifications for each buyer.

83. The network of claim 82, the code further instructing the server to assign a buyer qualification rating to each buyer within the buyers database based on buyer purchasing qualifications included in the database for each buyer, wherein the first query results further include the buyer qualification rating for each buyer.

84. The network of claim 83, wherein the buyer qualification rating is further based on the supplemental information about each buyer.

85. The network of claim 73, the code further instructing the server to:
generate a second query of the buyers database, wherein the second query returns second query results including the purchasing criteria and the buyer agent information for one or more of the buyers entered into the buyers database within a recent predetermined period; and
transmitting the second query results to agents for sellers of properties.

86. The network of claim 73, wherein the first query results include a plurality of buyers grouped by purchasing criteria having a common geographical identifier.

87. The network of claim 86, wherein the common geographical identifier refers to one or more of a neighborhood, a community, a subdivision, a school district, and a city.

88. The network of claim 73, the code further instructing the server to receive geographical location data from a plurality of remote devices, each associated with one of a plurality of active buyers in the database, wherein the first query results include one or more of the plurality of active buyers grouped by proximity to a geographical location identified in the first query.

89. The network of claim 88, wherein the geographical location is a location of a property offered for sale.

90. The network of claim 73, wherein the purchasing criteria includes a plurality of predetermined categorizations and at least one free form entry field.

91. The network of claim 90, the code further instructing the server to apply an inference matching algorithm to the at least one free form entry field as part of returning the first query results.
